(19) United States
(12) Patent Application Publication
(10) Pub. No.: US 2022/0383625 A1
(43) Pub. Date: Dec. 1, 2022

(54) A SYSTEM AND METHOD FOR DETECTING A PROTECTIVE PRODUCT ON THE SCREEN OF ELECTRONIC DEVICES

(71) Applicant: World Wide Warranty Life Services Inc., Port Moody (CA)

(72) Inventors: Richard Hui, Port Moody (CA); Anthony Daws, Vancouver (CA); Ebrahim Bagheri, Toronto (CA); Fattane Zarrinkalam, Toronto (CA); Hossein Fani, Toronto (CA); Samad Paydar, Toronto (CA)

(21) Appl. No.: 17/770,458

(22) PCT Filed: Oct. 21, 2020
(86) PCT No.: PCT/CA2020/051413

§ 371 Date: Apr. 20, 2022

Related U.S. Application Data
(60) Provisional application No. 62/923,873, filed on Oct. 21, 2019.

(51) Int. Cl. G06V 10/77; G06V 10/764; G06V 20/64

(52) U.S. Cl. CPC G06V 10/7715; G06V 10/764; G06V 20/64

(57) ABSTRACT

Embodiments are described herein for an electronic device, system and method for remotely detecting whether or not the electronic device has a screen protector placed over its display screen. The electronic device is placed face-down on a flat, opaque surface, such that the display screen and front camera of the electronic device are also face-down and the electronic device takes a series of photos with the camera. The series of photos is analyzed to determine whether or not the screen protector is attached to the display screen of the electronic device, which can be communicated electronically.

### CROSS-REFERENCE TO RELATED PATENT APPLICATION

This application claims the benefit of U.S. Provisional Patent Application No. 62/923,873, filed Oct. 21, 2019, entitled “SYSTEM AND METHOD FOR DETECTING A PROTECTIVE PRODUCT ON THE SCREEN OF ELECTRONIC DEVICES”. The entire content of U.S. Provisional Patent Application No. 62/923,873, is herein incorporated by reference.

### FIELD

The instant disclosure pertains generally to the field of electronic devices, particularly portable electronic devices having a display screen, and protective coverings for such a display screen. More specifically, the instant disclosure pertains to various embodiments of a system and method for detecting whether or not an electronic device has a protective covering placed over its display screen.

### BACKGROUND

It is highly probable that electronic devices, such as cell phones, smart watches, tablets, laptops, and similar devices, could greatly be damaged by experiencing an unintended impact. For the purposes of the instant disclosure, an impact can be defined as a device receiving force from a drop of the device or another applied external force to the device itself. Screen damage is one of the most common and costly forms of damage to an electronic device. Therefore, users often buy one of several different types of available screen protection products, also referred to as screen protectors or screen covers, including tempered glass screen protectors, liquid glass screen protection, thermoplastic polyurethane (TPU) plastic and multi-layered screen protectors, to avoid costly screen repairs.

In some cases, electronic devices may be used in environments, such as a construction site, a mining site or a manufacturing plant, for example, where the electronic devices may be easily damaged if a screen protection product is not used. Accordingly, safety protocols in such environments, to protect users of the electronic devices, may require the electronic devices to have screen protection products. In other cases, warranty administrators and insurance companies provide insurance coverage to screen protection products to support warranty repair service. However, such coverage is not applied to insurance claims resulting from damage that occurs when an electronic device is not protected by a screen protection product such as a screen cover. Accordingly, there is a need for a system and method to evaluate an electronic device to determine if the device actually has a screen protector applied and in use. The ability to determine that a screen protector has been applied to a specific, registered electronic device, allows an employer to determine if a user is following safety protocols and/or a warranty provider to provide an increased level of assurance that warranty claims against such a device are valid, while mitigating fraudulent claim attempts by consumers who did not actually apply a screen protection product to their electronic device.

### SUMMARY OF VARIOUS EMBODIMENTS

In accordance with a broad aspect of the teachings herein, there is provided at least one embodiment of a method for detecting a presence or absence of a screen protector on an electronic device, wherein the method comprises: ensuring that a front surface of the electronic device is placed in a stable manner on a flat opaque surface based on motion sensor data obtained by motion sensors of the electronic device; disabling a flash of the electronic device, displaying a first color, optionally having a first pattern, on a display screen of the electronic device, and then taking a reference photo using a front camera of the electronic device in order to obtain reference image data; displaying a second color, optionally having a second pattern, on the display screen of the electronic device, optionally enabling and discharging the flash and taking a first evidence photo using the front camera to obtain first evidence image data; analyzing the reference image data and the first evidence image data to detect whether the screen protector was present or absent when the reference image data and the first image data were obtained; and indicating, based on the analysis, that the screen protector either is present or is absent from the electronic device.

In at least one embodiment, the method further comprises displaying a white color on the display screen of the electronic device, optionally enabling and discharging the flash, and taking a second evidence photo using the front camera to obtain second evidence image data and the analysis is performed on the reference image data, the first evidence image data and the second evidence image data.

In at least one embodiment, the first color is black and the second color is white.

In at least one embodiment, the first and second patterns are solid.

In at least one embodiment, the motion sensor data is obtained by the electronic device and is processed to determine whether or not the front surface of the electronic device is placed in a stable manner against the flat surface and when the electronic device is not placed in a stable manner against the flat surface, the method comprises alerting a user to reposition the electronic device to so that the electronic device is placed in a stable manner against the flat surface.

In at least one embodiment, the motion sensor data includes acceleration data and rotation data, and the method determines that the electronic device is placed in a stable manner against the flat surface based on comparing a magnitude of an acceleration value determined from the acceleration data to an acceleration threshold and comparing pitch and roll values from the rotation data to ranges of roll and pitch values that are associated with a face down orientation for the electronic device.

In at least one embodiment, the analysis of the image data comprises extracting values for at least one feature of the obtained image data using image processing techniques.

In at least one embodiment, the method further comprises processing the values for the at least one extracted feature of the obtained image data with a pre-trained binary classifier to determine whether the input values belong to a “with screen protector” which indicates that the electronic protector is present with the electronic device or a “without screen protector” class which indicates that the electronic protector is not with the electronic device.

In at least one embodiment, the pre-trained binary classifier is based on an XGBoost algorithm, Singular Value Decomposition (SVD), Naive Bayes, Logistic Regression, k-Nearest Neighbors (k-nn), Gradient boosting. Random Forest, or an ensemble method.

In at least one embodiment, the at least one feature is any combination of a color histogram, a Histogram of Oriented Gradients, a Gradient location-orientation histogram, an Image Gradient, an Image Laplacian, textural features, fractal analysis, Minkowski functionals, a wavelet transform, a gray-level co-occurrence matrix, a size zone matrix, and run length matrix (RLM).

In at least one embodiment, the values for the at least one feature are computed over a filtered version of the reference and evidence image data.

In at least one embodiment, a device processing unit of the electronic device is used to ensure that the front surface of the electronic device is placed in a stable manner on a flat opaque surface.

In at least one embodiment, the image data is sent to a server where a server processing unit performs the analysis of the image data to determine the presence or absence of the screen protector on the electronic device.

In at least one embodiment, the device processing unit performs the analysis of the image data to determine the presence or absence of the screen protector on the electronic device.

In at least one embodiment, the method comprises remotely sending a command to the electronic device to initiate the method for detecting the presence or absence of the screen protector.

In another broad aspect, in accordance with the teachings herein, in at least one embodiment there is provided a system for detecting a presence or absence of a screen protector on an electronic device, wherein the system comprises: the electronic device including: a display screen for generating and displaying colors, a camera for taking photos and obtaining image data therefrom; a flash for the camera, the flash being optional; a communication device for communicating with remove device; a memory for storing programming instructions for performing one or more steps of a screen protector detection method; and a device processing unit for controlling the operation of the electronic device, the device processing unit being operatively coupled to the display screen, the camera, the flash, the communication device and the memory, wherein when the device processing unit, when executing the software instructions, is configured to: obtain motion sensor data that is used to ensure that a front surface of the electronic device is placed in a stable manner on a flat opaque surface; disable the flash, display a first color, optionally having a pattern, on the display screen, and take a reference photo using the front camera in order to obtain reference image data; display a second color, optionally having a pattern, on the display screen of the electronic device, optionally enabling and discharging the flash and taking a first evidence photo using the front camera to obtain first evidence image data; and a server comprising a server processing unit that controls the operation of the server and a communication unit that is coupled to the server processing unit, wherein the server processing unit is configured to send a command to the electronic device to start the method for detecting the presence of absence of the screen protector, wherein the reference image data and the first evidence image data are analyzed to detect whether the screen protector was present or absent when the reference image data and the first image data were obtained; and an indication is provided, based on the analysis, that the screen protector either is present or is absent from the electronic device.

In at least one embodiment, the device processing unit is further configured to display a second color on the display screen of the electronic device, optionally enabling and discharging the flash, and taking a second evidence photo using the front camera to obtain second evidence image data and the analysis is performed on the reference image data, the first evidence image data and the second evidence image data.

In at least one embodiment, the motion sensor data is obtained by the electronic device and is processed to determine whether or not the front surface of the electronic device is placed in a stable manner against the flat surface and when the electronic device is not placed in a stable manner against the flat surface, the device processing unit is configured to generate a notification signal to alert a user to reposition the electronic device to so that the electronic device is placed in a stable manner against the flat surface.

In at least one embodiment, the motion sensor data includes acceleration data and rotation data, and the electronic device is determined to be placed in a stable manner against the flat surface based on comparing a magnitude of an acceleration value determined from the acceleration data to an acceleration threshold and comparing pitch and roll values from the rotation data to ranges of roll and pitch values that are associated with a face down orientation for the electronic device.

In at least one embodiment, the image data is sent to the server and the server processing unit is configured to perform the analysis of the image data to determine the presence or absence of the screen protector on the electronic device.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 shows a front view of a smartphone, which represents a typical electronic device with an embedded camera in a front surface (e.g. face) thereof.

FIG. 2A shows a front view of the smartphone of FIG. 1 and the x and y coordinate axes that are used when acceleration is detected by a built-in accelerometer sensor.

FIG. 2B shows a side view of the smartphone of FIG. 1 and the z coordinate axis that is used when acceleration is detected by the built-in accelerometer.

FIG. 3A shows a front view of the smartphone of FIG. 1 and the x (pitch) and y (roll) coordinate axes that are used when movement is detected by the built-in rotation sensor along.

FIG. 3B shows a side view of the smartphone of FIG. 1 and the z (yaw) coordinate axis that is used when movement is detected by the built-in rotation sensor.

FIG. 4A shows a perspective view of a typical screen protector applied to a front of the smartphone depicted in FIG. 1.

FIG. 4B shows a side view and enlarged side view of the smartphone and applied screen protector of FIG. 4A.

FIG. 5 shows the smartphone of FIG. 1 placed face-down on a flat, opaque surface.

FIG. 6 shows an enlarged illustrated view of an electronic device with a screen protector, placed face-down on a flat opaque surface to demonstrate the effect of the screen protector on light rays bouncing into the camera lens of the electronic device.

FIG. 7 shows an enlarged illustrated view of an electronic device without a screen protector, placed face-down on a flat opaque surface to demonstrate differences in the effect of the light rays bouncing into the camera lens of the electronic device with regard to FIG. 6.

FIGS. 8A-8B illustrate a sample photo taken with the front camera of an electronic device in the presence and in the absence, respectively, of a screen protector when the display screen displays a white color and the camera flash is ON.

FIG. 9 is a block diagram of an example embodiment of an electronic device and its connection with a server for screen protector detection.

FIG. 10 shows a flowchart diagram of a method for detecting whether a screen protection product is installed on an electronic device in accordance with an example embodiment of the teachings herein.

FIG. 11 is an activity diagram illustrating in more detail, a sub-procedure executed by an example embodiment of the teachings herein for determining whether the electronic device is placed face-down in a stable manner on a surface.

FIG. 12 is an activity diagram illustrating a procedure executed by an Al-powered method according to an example embodiment of the teachings herein for detecting the presence or absence of a screen cover on the electronic device.

FIG. 13 is an activity diagram illustrating an example embodiment of a method, which may be performed at a server, for training a binary classification model which is used in the procedure shown in FIG. 11 to detect the presence or absence of a screen cover on an electronic device.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument such as, for example, a continuing patent application, and the applicants, inventors or owners do not intend to abandon, disclaim or dedicate to the public any such subject matter by its disclosure in this document.

For the purpose of simplicity and clarity of the illustrations, where considered appropriate, reference numerals may be repeated among the figures to indicate corresponding or analogous elements or steps. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Furthermore, it should be noted that reference to the figures is only made to provide an example of how various example hardware and software methods operate in accordance with the teachings herein and in no way should be considered as limiting the scope of the claimed subject matter. Also, the written description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical, optical or electrical connotation. For example, as used herein, the terms coupled or coupling can indicate that two elements or devices can be directly connected to one another or connected to one another through one or more intermediate elements or devices via an electrical, optical or magnetic signal, an electrical connection, an electrical element, an optical element or a mechanical element depending on the particular context. Furthermore, coupled electrical elements may send and/or receive data.

Unless the context requires otherwise, throughout the specification and claims which follow, the word “comprise” and variations thereof, such as, “comprises” and “comprising” are to be construed in an open, inclusive sense, that is, as “including, but not limited to”.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should also be noted that, as used herein, the phrase “at least one of X, Y and Z” is intended to cover all combinations of X, Y and Z including X, Y, Z, X and Y, X and Z, Y and Y, as well as X, Y and Z.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a”, “an”, and “the” include plural referents unless the content clearly dictates otherwise. It should also be noted that the term “or” is generally employed in its broadest sense, that is, as meaning “and/or” unless the content clearly dictates otherwise.

The headings and Abstract of the Disclosure provided herein are for convenience only and do not interpret the scope or meaning of the embodiments.

Similarly, throughout this specification and the appended claims the term “communicative” as in “communicative pathway,” “communicative coupling,” and in variants such as “communicatively coupled,” is generally used to refer to any engineered arrangement for transferring and/or exchanging information. Examples of communicative pathways include, but are not limited to, electrically conductive pathways (e.g., electrically conductive wires, electrically conductive traces), magnetic pathways (e.g., magnetic media), optical pathways (e.g., optical fiber), electromagnetically radiative pathways (e.g., radio waves), or any combination thereof. Examples of communicative couplings include, but are not limited to, electrical couplings, magnetic couplings, optical couplings, radio couplings, or any combination thereof.

Throughout this specification and the appended claims, infinitive verb forms are often used. Examples include, without limitation: “to detect”, “to provide”, “to transmit”, “to communicate”, “to process”, “to route”, and the like. Unless the specific context requires otherwise, such infinitive verb forms are used in an open, inclusive sense, that is as “to, at least, detect”, to, at least, provide”, “to, at least, transmit”, and so on.

The example embodiments of the systems and methods described herein may be implemented as a combination of hardware or software. For example, a portion of the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a keyboard, touchscreen, or the like), and at least one output device (e.g. a display screen, or the like) and a communication interface including one or more ports and/or radios depending on the nature of the device.

It should also be noted that there may be some elements that are used to implement at least part of the embodiments described herein that may be implemented via software that is written in a combination of high-level procedural language such as object-oriented programming as well as assembly language, machine language, or firmware as needed. For example, the program code may be written in C, C++ or any other suitable programming language and may comprise modules or classes, as is known to those skilled in object-oriented programming.

At least some of the software programs used to implement at least one of the embodiments described herein may be stored on a storage media (e.g., a computer readable medium such as, but not limited to, ROM, magnetic disk, optical disc) or a device that is readable by a programmable device. The software program code, when read by the programmable device, configures the programmable device to operate in a new, specific and predefined manner in order to perform at least one of the methods described herein.

Furthermore, at least some of the programs associated with the devices, systems and methods of the embodiments described herein may be capable of being distributed in a computer program product comprising a computer readable medium that bears computer usable instructions, such as program code, for one or more processors. The program code may be preinstalled and embedded during manufacture and/or may be later installed as an update for an already deployed computing system. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

It should also be noted that the term “cloud” as used herein describes a network of computing equipment distributed over multiple physical locations and accessible over a communications network such as the Internet, for example.

It should also be noted that the term “Al-powered model” as used herein describes a mathematical model that is developed based on sample data, known as training data, used to make predictions or decisions about one or more use case scenarios. The model may be based on one or more algorithms obtained from Artificial Intelligence techniques known in Computer Science but specifically modified based on the one or more use case scenarios.

It should also be noted that the term “binary classifier” as used herein describes an Al-powered model whose task is to classify a given input, usually in form of a vector of values, into either of two groups, which represent positive and negative outcomes for a given use case scenario.

In the following detailed description, various example embodiments are discussed of a device, system and method for automatically detecting the presence and/or absence of a screen protector on an electronic device. The various embodiments of the devices, systems and methods described herein provide a person or an entity with the ability to determine if the screen of an electronic device is covered by a screen protector, by processing photos (also known as images, or image data for one image and image data sets for multiple images) taken during a screen protector detection method with a camera installed at a front surface of the device. The analysis of the image data obtained during the screen protector detection method may be performed at the electronic device or remotely from the electronic device such as by a remote server. Most portable electronic devices have an integrated camera that can be used for performing the screen protector detection method.

For example, it has been appreciated that users of electronic devices may benefit from receiving alerts (or notifications) when protective cases are not applied to their electronic devices. For example, in many cases, users may not be aware that a protective case has inadvertently de-detached from their electronic device. Otherwise, the protective case may have been removed, but the user may have inadvertently omitted to re-apply the case to the electronic device after removal. In these cases, alerting the user to the absence of the protective case from the electronic device can provide the user an opportunity to re-apply the case, and thereby reduce the risk of unforeseen damage to the electronic device.

Similarly, it has also been appreciated that monitoring the presence of protective cases on electronic devices can also provide benefits to manufacturers, who in collaboration with warrantors or individually, provide warranty coverage to damaged electronic devices. For example, in various cases, before validating a claim of warranty over a damaged device, manufacturers and/or warrantors will often require assurances that a protective case was applied to the electronic device at the point (i.e. time and location) of damage. Accordingly, it may be desirable to automatically monitor and detect the presence of protective cases on electronic devices at the time of damage.

The screen protector detection method involves placement of the electronic device face-down on a flat opaque surface near the beginning of the detection method, wherein the electronic device's integrated camera's lens and field of view are perpendicular with regard to the face-down surface of the electronic device. In accordance with the teachings herein, if the screen of the electronic device is covered by a screen protector, there is an increased space between the camera and the flat opaque surface due to the addition of a layer of transparent material from which the screen protector is composed. This increased space allows for more light to bounce from the device's display screen and/or front-facing flash into the camera's lens while photos (i.e. images) are being obtained using the front camera compared to when the electronic device is not covered by a screen protector. In other words, the inventors have found that there is a sufficient difference between the photos (i.e. image data) that are obtained when the screen protector is present compared to the photos/image data that are obtained when the screen protector is absent, such that automated analysis using a machine learning algorithm can determine whether a screen protector is on the electronic device when the photos are taken. When the detection method process is complete, the user may be notified via a sound alert so that the user knows that they may now pick up and continue using their electronic device.

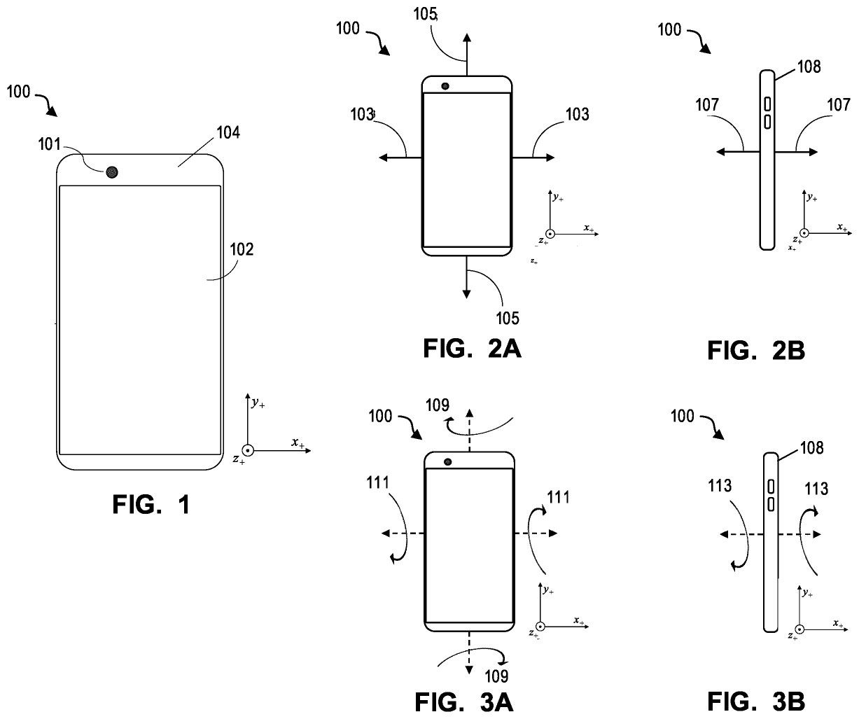

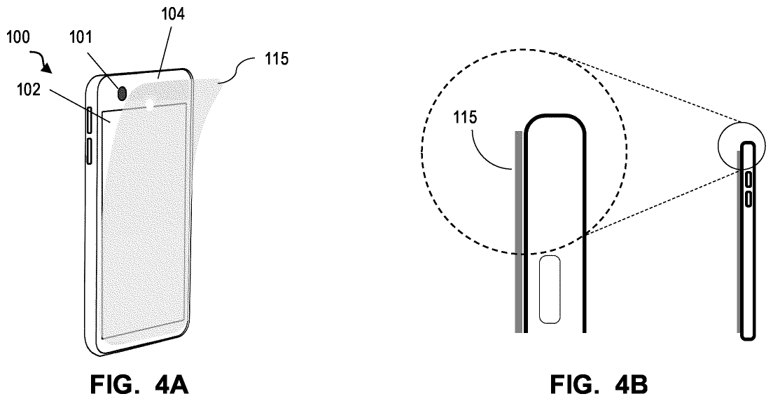

It should be noted that when the screen protector is present with the electronic device it means that the screen protector is applied to (i.e. installed on) the electronic device, an example of which is shown in FIG. 4B. Further, when the screen protector is absent from the electronic device it means that the screen protector is not applied to or installed on the electronic device, an example of which is shown in FIGS. 1-3B.

FIGS. 1-3B, 4A, 4B, 5 and 9 show a smartphone, which is as an example of an electronic device 100, to illustrate the operation of the teachings herein. However, the scope of the present teachings includes all similar electronic devices such as other smartphones, tablets, laptops, and electronic book readers equipped with an integrated front camera 101 having a front-facing flash 120, a built-in accelerometer sensor 134 and a rotation sensor 136. All such electronic devices 100 have in common a front camera 101 that is installed along a front surface 104 of the housing of the electronic device 100. The electronic device 100 further includes a display screen 102. The accelerometer sensor 134 can be used to measure acceleration data including the acceleration force in m/s² that is applied to or experienced by the electronic device 100, including the force of gravity, in any direction along three physical axes, including the X axis 103, the Y axis 105, and the Z axis 107. The rotation sensor 136 can be used to provide rotation data including the pitch 109, roll 111 and yaw 113 angles of the electronic device 100 relative to the normal horizon, including in either clockwise or counterclockwise directions for each rotation 109, 111, and 113. Moreover, FIGS. 4A and 4B show a sample screen protector 115 located at the front surface 104 of the example electronic device 100 illustrated in FIG. 1. A screen protector 115 is any apparatus or product that covers the screen of an electronic device in order to protect it from damage.

The teachings herein can be used to determine the presence or absence of the screen protector 115 on the electronic device 100 by processing the photos (i.e. image data) taken by the front camera 101 while using the electronic device's display screen 102 and/or front-facing flash to illuminate a substantially flat, opaque surface 106 upon which electronic device 100 is in contact with and the front camera 101 is facing. The surface is substantially flat if, at a macro level, the surface 106 is planar along a length and width that makes contact with the front surface of the electronic device 100.

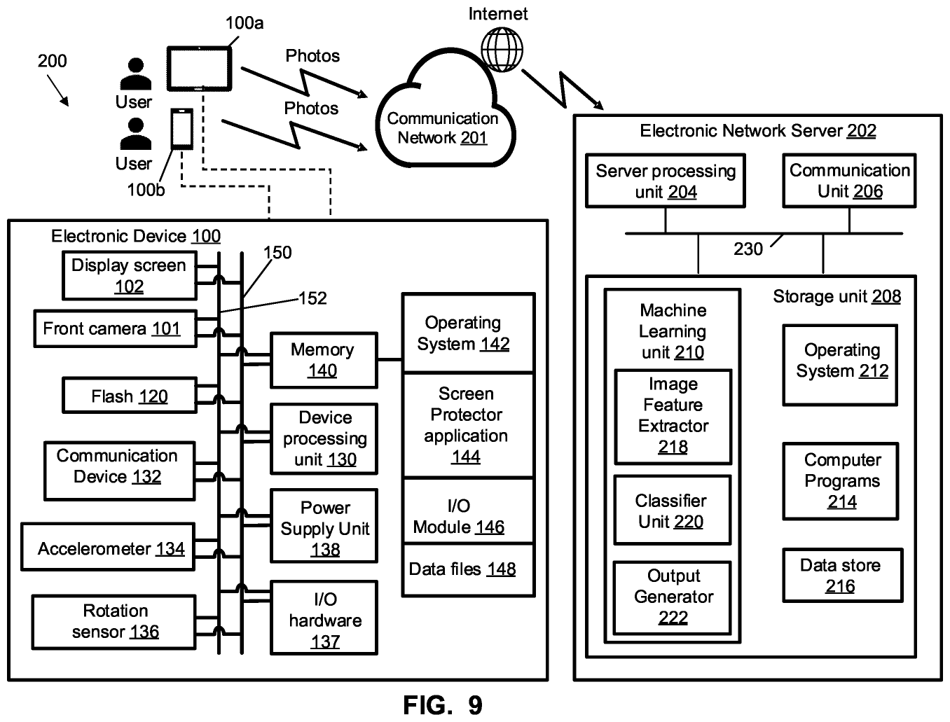

As shown in FIG. 9, an example embodiment of the electronic device 100 includes the front camera 101, the display screen 102, the flash 120, a device processing unit 130, a communication device 132, the accelerometer sensor 134, the rotation sensor 136, a power supply unit 138, and a memory 140. The memory 140 is used to store various items including, but not limited to, program instructions for an operating system 142, a screen protector application 144, and an I/O module 146. The memory 140 also stores data files 148. Various elements of the electronic device 100 can communicate using a data bus 150 and can receive power from voltage rails 152 from voltages that are provided by the power supply unit 138. It should be noted that in other embodiments, the electronic device 100 may generally include different components.

The device processing unit 130 may include a suitable processor that has sufficient processing power. For example, the device processing unit 130 may include a high performance processor. Alternatively, in other embodiments, there may be a plurality of processors that are used by the device processing unit 130 and these processors may function in parallel and perform certain functions. The device processing unit 130 controls the operation of the electronic device 100.

The display screen 102 (and associated display electronics) may be any suitable display element that can emit light and provides visual information including display images, text and Graphical User Interfaces (GUIs). For instance, the display screen 102 may be, but is not limited to, an LCD display, or a touch screen depending on the particular implementation of the electronic device 100. In some cases the display screen 102 may be used to provide one or more GUIs through an Application Programming Interface for a local software application and/or for a remote Web-based application that is accessible via a communications network 201. A user may then interact with the one or more GUIs for performing certain functions on the electronic device 100 including performing the screen protector detection method.

The front camera 101 and the flash 120 can be a camera and flash that are typically integrated into electronic devices such as smart phones, tablets and note pads. Likewise, the accelerometer 134 and the rotation sensor 136 can be sensors that are typically used by integrated into electronic devices such as smart phones, tablets and note pads. The rotation sensor 136 may be implemented using a gyroscope.

The communication device 132 includes hardware that allows the device processing unit 130 to send data to and receive data from other devices or computers. Accordingly, the communication device 132 may include various communication hardware, depending on the implementation of the electronic device 100, for providing the device processing unit 130 with alternative ways to communicate with other devices. For example, the communication hardware generally includes a long-range wireless transceiver for wireless communication via the network 201. The long-range wireless transceiver may be a radio that communicates utilizing CDMA, GSM, or GPRS protocol according to standards such as IEEE 802.11a, 802.11b, 802.11g, 802.11n or some other suitable standard. In some cases, the communication hardware may include a network adapter, such as an Ethernet or 802.11x adapter, a modem or digital subscriber line, a Bluetooth radio or other short range communication device. In some cases, the communication hardware can include other connectivity hardware including communication ports as is known by those skilled in the art, such as a USB port that provides USB connectivity, for example.

The I/O Hardware 137 includes at least one input device and one output device depending on the implementation of the electronic device 100. For example, the I/O hardware 137 can include, but is not limited to, a keyboard, a touch screen, a thumbwheel, a track-pad, a track-ball, a microphone and/or a speaker.

The power supply unit 138 can be any suitable power source and/or power conversion hardware that provides power to the various components of the electronic 100. For example, in some cases, the power supply unit 138 may include a power convertor, surge protection circuitry and a voltage regulator that are connected to a power source, which is typically a rechargeable battery. The power supply unit 138 provides protection against any voltage or current spikes. In other embodiments, the power supply unit 138 may include other components for providing power as is known by those skilled in the art.

The memory 140 can include RAM, ROM, one or more flash memory elements and/or some other suitable data storage elements depending on the configuration of the electronic device 10. The memory 140 stores software instructions for an operating system 142, a screen protector application 144, and an I/O module 146. The memory 140 also stores data flies 148. The various software instructions, when executed, configure the processor unit 130 to operate in a particular manner to implement various functions for the electronic device 100.

The screen protector application 144 is a software program including a plurality of software instructions, which when executed by the device processing unit 130, configure the device processing unit 130 to operate in a new and specific manner for performing functions that are used to detect whether the screen protector 115 is applied to the electronic device 100 at the time of performing a screen protector detection method. In some embodiments, initial steps of the screen protector detection method may be performed by the device processing unit 130 such as obtaining taking photos to obtain image data that is used along with machine learning to determine whether the screen protector 115 is applied to the electronic device. In this case, the machine learning unit 214 may be located at a server 202. In other embodiments, the functionality of the machine learning unit 214 may be provided by the screen protector application 144 and the detection results are sent to the server 202. Regardless of where the functionality of the machine learning unit 214 is implemented, the screen protector application 144 may include software instructions for causing the device processing unit 130 to generate and provide instructions to a user of the electronic device 100 for actions that the user performs during the operation of the screen detection method. The screen protector application 144 may also include instructions for causing the device processing unit 130 to notify the user that the screen detection method has commenced, whether there is an error during the operation of the screen detection method and when the screen detection method has ended. For example, these notifications may be sounds or speech that are generated by the device processing unit 130 and output via a speaker (not shown) of the electronic device and/or these notifications may be vibrations which are generated by a vibration element (not shown), such as a vibration motor, of the electronic device 100 under the control of the device processing unit 130.

The I/O module 146 may be used to store information in the data files 148 or retrieve data from the data files 148. For example, any input data that is received through one of the GUIs can be stored by the I/O module 146. In addition, any image quality data that is required for display on a GUI may be obtained from the data files 148 using the I/O module 146 or any operational parameters that are needed for provision of any of the functions provided by the screen protector application 144 may be obtained from the data files 148 using the I/O module 146. For example, the data files 148 may include notifier files that include data for providing the notifications to the user during the operation of the screen protector detection method. In alternative embodiments, where the device processing unit 130 is configured to perform the functionality of the machine learning unit 210, certain parameters for employing a machine learning algorithm may be stored in the data files 148. In some embodiments, the data files 148 may include a file in which the detection method results from performing the screen protector detection method are stored.

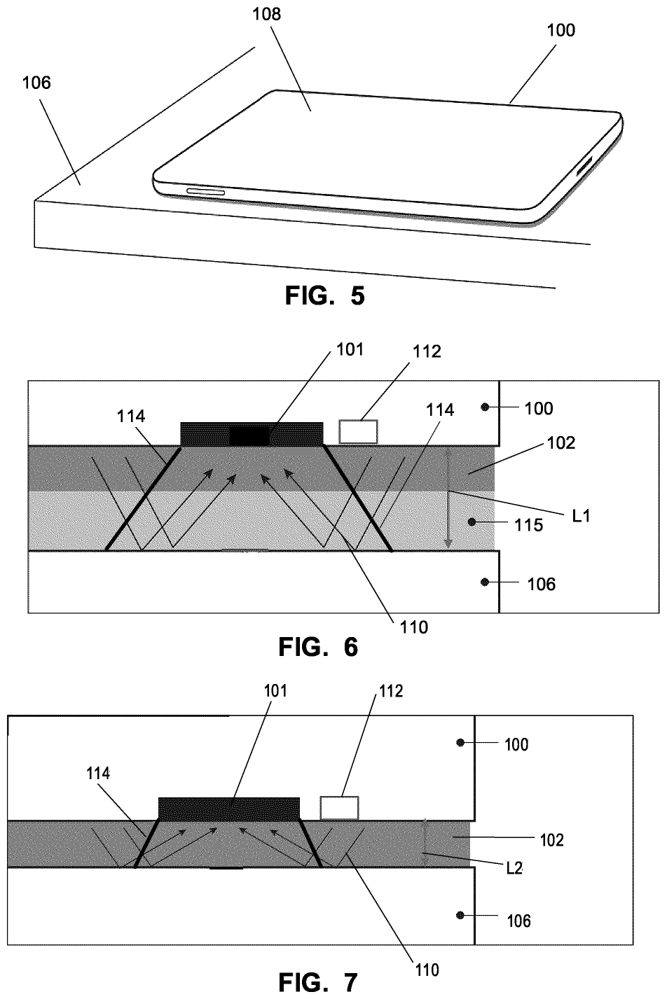

Referring now to FIG. 5, the electronic device 100 is placed face-down on the flat opaque surface 106, such as a table, so that the front surface 104 of the electronic device 100 is not visible and a back surface 108 is exposed. Placing the electronic device 100 face-down greatly reduces the amount of ambient light that can be captured by the camera 101 when a photo is taken. Further, the surface 106 is opaque so as to further reduce introduction of ambient light into the camera 101 when a photo is taken and to ensure that at least some emitted light from the display screen 102 and/or the flash 112 when it is discharged is reflected into the lens of the camera 101 when the camera 101 is taking a photo (i.e. obtaining image data). Once the electronic device 100 is placed face-down on the surface 106, light 110 is then emitted from the display screen 102 and/or the flash 112. When it is discharged As illustrated in FIG. 6, with the presence of a screen protector 115 on the electronic device 100, the electronic device 100 is raised slightly from the surface 106, such that there is an increased length (L1) between the front camera 101 and the surface 106 from which the emitted light (from the flash 112 and/or the display screen 102) is reflected such that the emitted light 110 is in the field of view 114 (shown in thick solid lines) of the front camera 101. The increased length allows more light from the display screen 102 and the front-facing flash 112 to reflect off of the opaque surface 106 and into the lens of the front camera 101. In this case, light rays that are emitted from the flash 120 and/or the display screen 102 is passed through the layer(s) of the screen protector 115 are also refracted, i.e. the light rays are bent, so the amount of light that is reflected and reaches the lens of the camera 101 is different, compared to when the screen protector 115 is not applied to the electronic device 100. So, applying the screen protector 115, both increases the distance travelled by the emitted light rays and also has a refractive effect, which both affect the image taken by the camera 101. FIG. 7 shows a similar close-up illustration of the device 100 positioned face-down on a surface 106, but without a screen protector 115. Without a screen protector 115, there is a smaller length (L2) of space between the surface 106 and the front camera 101 in which light 110 may reflect to enter the camera's field of view 114.

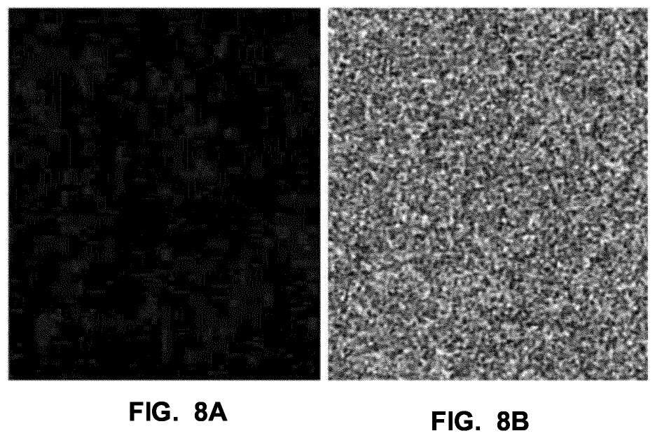

There is a noticeable difference between photos taken (i.e. image data obtained) by the camera 101 when the screen protector 115 is on the device 100 compared to those taken in the absence of the screen protector 115. To further illustrate this point, FIGS. 8A and 8B show two photos taken by the front camera 101 of an electronic device 100 when the display screen 102 displays a white color, the front-facing flash 112 is ON (i.e. discharged) when the photo was taken and the electronic device 100 is placed face-down on a table, which serves as the flat, opaque surface 106. FIG. 8A shows the photo taken by the electronic device 100 with the presence of the screen protector and FIG. 8B is the photo taken under the same conditions except that the screen protector 115 is not applied to the electronic device 100. Both photos were then processed by multiplying detected light levels by the same factor for this illustration in order to make the difference more easily visually observable. Such additional processing was done only for illustrative purposes and is not an absolute requirement for the screen protection detection method described herein. This behaviour has been seen on a variety of smart phones that are currently on the market in which the position of the camera lens may vary from the top left side, top middle or top right side of the front of the electronic device 100. By comparing the two sample photos show in FIGS. 8A and 8B, it is evident that using the screen protector 115 when taking the phot has an impact on the resulting photo. Therefore, by analyzing the photo, it is possible to determine the presence or absence of the screen protector 115 on the electronic device 100.

Referring again to FIG. 9, shown therein is a block diagram of an example embodiment of a system 200 for performing screen protector detection on the electronic device 100 which communicates with an electronic network server 202 (hereafter referred to as server 202) to detect if the screen protector 115 has been applied to the electronic device 100. As shown in FIG. 9, the photos (i.e. image data) taken by the camera 101 are sent through a communications network 201 to the server 202 where they are processed to perform screen protection detection. In at least one alternative embodiment, the motion sensor data obtained via the accelerometer 134 and the rotation sensor 136 of the electronic device 100 may also be sent through the communications network 201 to the server 202 where the motion sensor data may be stored so that a central record of physical motion of the electronic device 100 may be maintained and reviewed at a later time and/or further analysis may be performed on the motion sensor data.

The communications network 201 can be any suitable network depending on the particular implementation of the server 202. In general, the nature of the communication network 201 is dependent on the communication technology used and the location of the server 202. For example, the communications network 201 may be an internal institutional network, such as a corporate network or an educational institution network, which may be implemented using a Local Area Network (LAN) or Intranet. In other cases, the communications network 201 can be an external network such as the Internet or another external data communications network, such as a cellular network, which is accessible by using a web browser on the electronic devices 100 to browse one or more web pages presented over the communication network 201.

The server 202 comprises a communication unit 206, a server processing unit 204 and a storage unit 208 that stores various software program files with program instructions for implementing a machine learning unit 210, an operating system program 212, and computer programs 214. The storage unit 208 also includes a data store 216 for storing data files. The server processing unit 204 is communicatively coupled to the communication unit 206 and the storage unit 208 via data bus 230. Although not shown, the server 202 includes hardware for generating and distributing power to the various components of the server 202 as is known to those skilled in the art. It should be understood that in other embodiments, the server 202 may have a different configuration and/or different components as long as the functionality of the server 202 is provided according to the teachings herein.

The server processing unit 204 controls the operation of the server 202 and can be any suitable processor, controller or digital signal processor that can provide sufficient processing power depending on the configuration and requirements of the server 202 as is known by those skilled in the art. For example, the server processing unit 204 may include one or more high-performance processors. The storage unit 208 is implemented using memory hardware as is known by those skilled in the art and can include RAM, ROM, one or more hard drives, one or more flash memory drives or some other suitable data storage elements such as disk drives, etc. The operating system 212 provides various basic operational processes for the server 202. The computer programs 214 include various user programs so that the electronic device 100 can interact with the server 202 to perform various functions.

The server processing unit 204, upon executing the program instructions from the Machine Leaning unit 214, becomes configured to perform various functions including performing training on the machine learning model that is employed in the detection process and processing the photos (i.e. image data) obtained by the electronic device to identify the presence or absence of the screen protector 115 on the display screen 104 of the electronic device 100. The machine learning unit 214 includes software instructions for implementing functionality for three main components: an Image feature extractor 218, a classifier unit 220 and an output generator 222. The machine learning unit 214 may also include software instructions for initiating the execution of the screen protector detection method so that when it is executed by the server processing unit 202, the server processing unit will send a command to the electronic device 100 to start the screen protector detection method. In some embodiments, the machine learning unit 214 can also include software instructions for providing an API (Application Programming Interface) that may be called by the electronic device 100 at which time the electronic device 100 will also send the obtained image data and optionally the obtained motion sensor data. The machine learning unit 214 can then perform the processing steps of the screen protector detection method, as described in further detail below, store the detection method result and optionally send the detection method result to the electronic device 100.

The Image feature extractor 218 includes a set of program instructions for implementing an image processing tool that is used to extract at least one feature from the image data that is obtained by the electronic device. An example of the features there is the color histogram of the image data for each image. For example, at least one feature can be extracted from image data for a single photo that was taken, or image data from two different photos can be combined (e.g. by addition or subtraction) and at least one feature may be extracted from the combined image data. While at least one feature is used at a minimum, performance of the screen protector detection method increases when more features are used. The number of features to be used can be determined from training the Al-powered model. The extracted features may be determined from any combination of a color histogram, a Histogram of Oriented Gradients (HOG), a Gradient location-orientation histogram (GLOH), an Image Gradient, an Image Laplacian, textural features, fractal analysis, Minkowski functionals, wavelet transform, gray-level co-occurrence matrix (GLOM), size zone matrix (SZM), and run length matrix (RLM). The features may be computed over a filtered version of the image. The filtering may be any suitable image filtering such as, but not limited to, Gaussian filtering, median filtering, and the Deriche filter.

The classifier unit 220 includes a set of program instructions for implementing a pre-trained binary classifier that receives at least one feature for each image processed by the image feature extractor 218 and determines a detection result for whether the images were obtained when the display screen 102 of the of the electronic device 100 was covered by the screen protector 115. Different algorithms can be used to implement the classifier unit 220 such as, but not limited to, Singular Value Decomposition (SVD), Naive Bayes, Logistic Regression, k-Nearest Neighbors (k-nn), Gradient boosting. or Random Forest, for example. In some embodiments, the classifier unit 220 may use multiple algorithms (referred to as ensemble methods) and then combine the results of the algorithms such as by employing majority voting, for example, to get a final result. In testing, the XGBoost algorithm has been seen to provide better results compared to other algorithms.

The output generator 206 includes a set of program instructions for receiving the detection result, and store the detection result in one or more data files in the data store 216. The output generator 206 may also include program instructions for configuring the server processing unit to send commands to the electronic device 100 so that a notification signal is generated and presented to the user to let them know that the screen detection method has completed. As mentioned before the notification signal may be a sound, speech or and/or vibration to let the user know about the status of the screen detection method such as in progress, pass (screen protector detected) and fail (screen protector not detected).

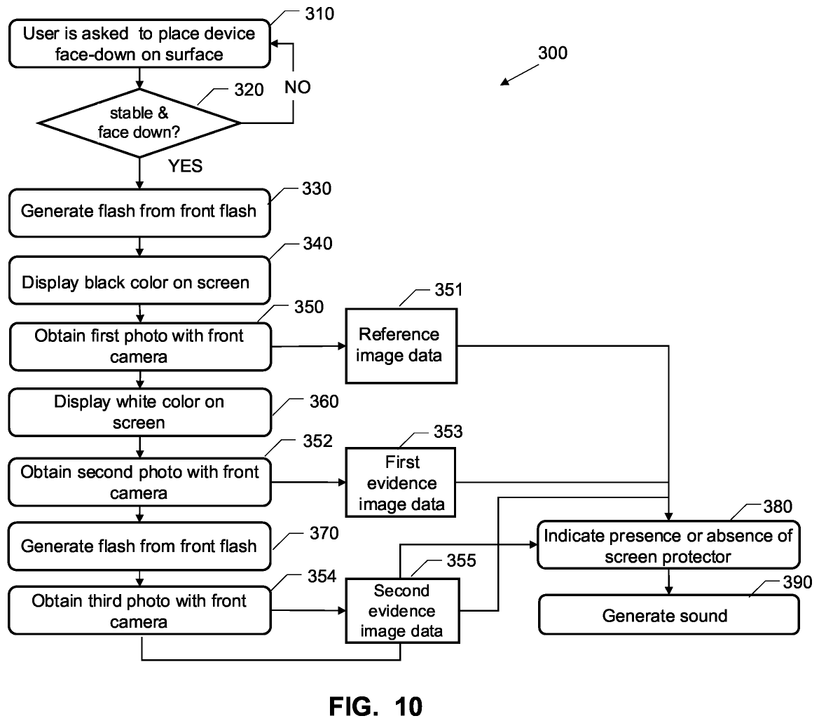

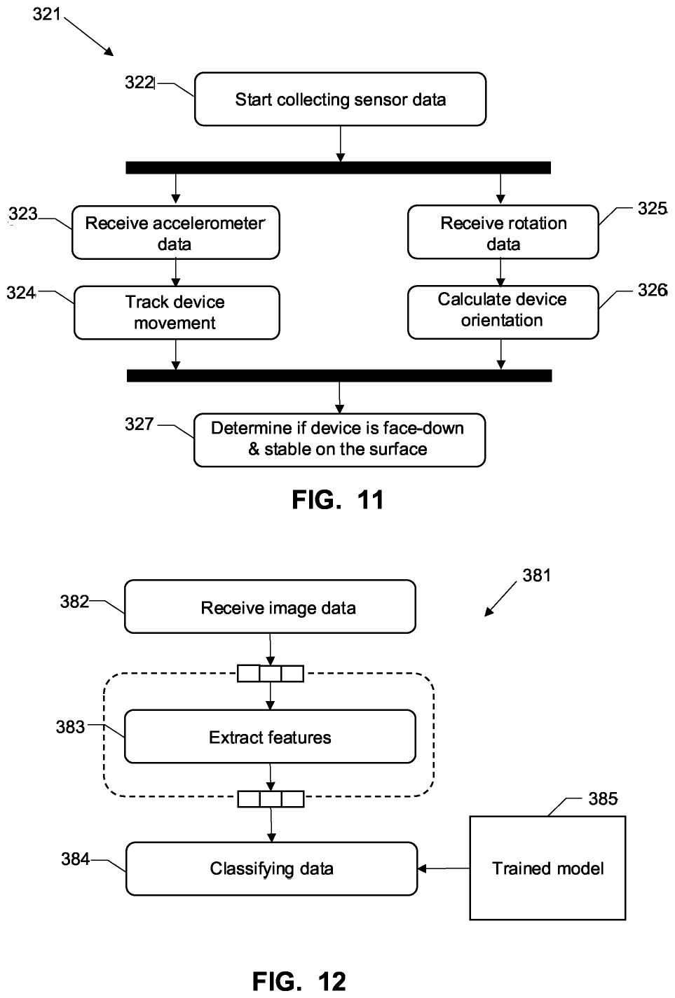

Referring now to FIG. 10, shown therein is an example embodiment of a screen protector detection method 300 for detecting the presence of a screen protector 115 on the electronic device 100. At step 310, a user is asked to place the electronic device 100 face-down on a flat opaque surface 106, such as a table. The user may be alerted to accomplish this step by an auditory message that is emitted from speakers installed in the electronic device 100 and/or by a message appearing on the display screen 102 of the electronic device 100 based on commands provided by the device processing unit 130. Until finishing the procedure 300, the electronic device 100 is left face down on the surface 106. Therefore, in step 310, the user may further receive a message, as previously described, informing the user to not move the device 100 until another notification, such as a tone for example, is played by the electronic device 100. In step 320, the procedure 300 checks if the electronic device 100 meets all of the detection conditions to start detecting the presence of the screen protection product 115 on the device. The detection conditions include whether the electronic device 100 is face down and laying against the flat, opaque surface 106 in a stable manner (i.e. the device is not moving). In step 320, motion sensor data from built-in sensors in the electronic device 100, such as acceleration data from the accelerometer 134 and rotation data form the rotation sensor, to detect if the electronic device 100 is face-down and stable on a surface. Accordingly motion sensor data includes both the acceleration data and the rotation data. An example method for processing the sensor data to determine if the detection conditions are true is shown in FIG. 11.

Once the electronic device 100 is detected as being in the correct position to perform the screen protector detection method, the procedure 300 proceeds to step 340 where the device processing unit 130 issues a command so that the display screen 102 just displays the color black and the display screen 102 then turns to all black. At step 350, the device processing unit 130 sets the front-facing flash 112 so that it is OFF and then takes a photo using the front camera 101 of the display screen 102 of the electronic device 100. Image data for this photo is called reference image data 351. The reference image data 351 allows the screen protector detection function performed at step 380, which is described in detail later, to determine how much of the detected light originates from the display screen 102 of the electronic device 100, as opposed to ambient or environmental light. In other words, the reference image data 351 is used to reduce the effect of environmental conditions on the screen protector detection algorithm. After step 350, the method 300 proceeds to step 360 where the device processing unit 130 issues a command for the display screen 102 to display only the color white which turns the display screen 102 to white and then at step 352 a second photo is taken with the front camera 101. Image data from the second photo is referred to as first image 353 which is used to detect the presence or absence of the screen protector 115 on the electronic device 100. The method 300 may optionally take another evidence photo to obtain second evidence image data 355, in which case in step 370, the device processing unit 130 configures the front-facing flash 112 to be set to ON and controls the display screen 102 to display the color white. While the display screen 102 is white, the device processing unit 130 instructs the front camera 101 to take another photo. The flash 120 is set to ON and goes off (i.e. is discharge) when taking the second evidence photo 355 because emitted light 110 from the flash 120 is orders of magnitude brighter than the backlight of the display screen 102. Since light reflects differently due to the layer provided by the screen protector 115 adjacent to the surface 106. As such, the flash 120 provides a better light source for the detection method 300 when such an appropriate flash 120 is available for use.

It should be noted that in an alternative embodiment, the flash 120 may be set to ON and go off (e.g. triggered to generate a second light, where the display screen 102 is generating a first light) when the first and second photos are taken to obtain the first and second evidence image data. Alternatively, in another embodiment, only light from the flash 120 or the display screen 102 may be generated when the photos are taken to obtain the first and second evidence image data; however, this may lead to a decrease in performance.

It should be noted that in another alternative embodiment, only a single photo needs to be taken to obtain first evidence image data when light is emitted from the display screen 102, the flash 120 or both the display screen 102 and the flash 120. However, operating the Al powered model on features extracted from just the reference image data and evidence image data from taking only one photo may reduce the accuracy of screen protector detection.

It should be noted that in another alternative embodiment, when the photos are taken to obtain the reference image data and the evidence image data, the display screen 102 can be controlled by the device processing unit 130 to display colors other than black and white, respectively. However, it is preferable to have a large contrast between the two colors that are selected. In some embodiments, the display screen 102 may be controlled to display different patterns when the photos are taken for the reference and evidence image data. For example, the different pattern may be gradient fill patterns or different texture patterns.

It is noted that the emitted light 110 from the flash 120 differs for different types and models of electronic devices in terms of color, intensity, and distance from the front camera, all of which is accounted for by a training method employed for developing the machine learning algorithm (which may be referred to as an Artificial Intelligence (AI) powered model) that is provided by the machine learning unit 210, which is then used to detect whether the screen protector 115 is applied to the electronic device 100 when the various photos are obtained. Accordingly, training data is obtained from different types/models of electronic devices, from which feature extraction is performed and the Al-powered model is trained. In this way, a single Al model may be trained and used for different manufacturers/models of electronic devices. Alternatively, training can be done separately for each electronic device using training data obtained from only that electronic device which will result in a single trained AI model for each manufacturer/model of electronic devices. In either training scenario, the larger the number of samples that are used for training, the more accurate the trained AI model(s) will be. Each training sample includes a set of images that corresponds to how the method 300 operates. For examples, if one reference and two evidence photos are taken from method 300 then each training sample has three image data sets: a reference image data set and two evidence image data sets. Also, one such sample can be obtained for a given manufacturer/model of an electronic device with the screen protector 115 and another sample can be obtained when the electronic device does not have the screen protector 115. This is then repeated K times. Together, these two sets of K samples form the training dataset. The training dataset may be a labeled dataset as it is known to which class each of the samples belong, i.e. the WITH-SCREEN-PROTECTOR class or the WITHOUT-SCREEN-PROTECTOR class. Then, a machine learning techniques can be used, such as one of the supervised learning methods, to train the Al model over the training dataset so that after training the Al-powered model can take a new sample (e.g. 3 image datasets) and classify this sample in one of the above mentioned classes. Training may involve using about 300 samples. The training can be done periodically to tune performance of the Al-powered model (i.e. the classifier) over time, for example as new samples are made available, so that the accuracy of the Al-powered model is improved over time.

The method 300 then proceeds to step 380 where the reference image data 351 and the first and second evidence image data 353 and 355, are processing for detecting the presence or absence of the screen protector 115 on the electronic device 100. Further explanation of how step 380 may be performed is illustrated in FIG. 12. As explained before by FIGS. 8A and 8B, there is a noticeable difference between the image data obtained when white color is displayed on the display screen 102 and the screen protector 105 is applied to the electronic device 100 compared to the when the screen protector 105 is not applied to the electronic device 100. Therefore, by extracting features of the image data, it is possible to train an Al-powered model to distinguish between the image data that is obtained when a screen protector 115 is applied to the electronic device and the image data that is obtained when the screen protector 115 is not applied to the electronic device 100 (also referred to as the absence of the screen protector 115). Step 380 produces a detection result, and the screen protector detection procedure 300 may be terminated in step 390 at which point a notifier is provided to the user, such as a tone that is output through a speaker of the electronic device 100, to inform the user that the procedure 300 has successfully completed.

Referring now to FIG. 11, a method 321 for automatically detecting when the electronic device 100 is face-down and stable on a surface is illustrated in greater detail. Method 321 can be used to implement the process of decision block 320 in the procedure 300. By tracking the sensor data that is obtained by motion sensors, i.e. the accelerometer 134 and/or the rotation sensor 136, it is possible to track the movement and orientation of the electronic device 100. As shown in FIG. 11, at step 322, the method 321 first starts to collect data from the motion sensors. Next, through steps 323 and 325, which are done in parallel, the method 321 receives the data from the accelerometer sensor 134 and the rotation sensor 136, respectively. The collected accelerometer sensor data (i.e. measured acceleration along the X 105, Y 107, and Z 109 axes) are sent to step 324 where this data is processed to track the movement of the electronic device 100 by calculating the magnitude of the acceleration value (e.g. square root of the square of the acceleration values along each axes). If the magnitude of the acceleration value is less than an acceleration threshold, which is determined to represent when the electronic device 100 is at rest, the electronic device 100 is determined to be stable (i.e. the electronic device 100 is not moving in which case the surface 106 does not necessarily need to be flat as long as the electronic device 100 is laying flat against the surface 106 and not moving). In parallel, at step 326, after receiving the pitch 111 and roll 109 values of the electronic device 100 obtained by the rotation sensor 136, the method 321 determines the orientation of the electronic device 100. For each orientation type (e.g. face-up, face-down and edge), a range of pitch and roll values are empirically determined. Therefore, the rotation sensor data obtained at step 325 can be used to identify the orientation of the electronic device 100 by determining in which range the value of the measured pitch and roll belong and what the corresponding orientation is for the determined range. Whenever the analysis of steps 324 and 326 is completed, step 327 returns “Yes” if the analysis of step 324 indicates that the electronic device 100 is not moving (i.e. the calculated acceleration magnitude is lower than the acceleration threshold) and if the analysis of step 326 determines that the range of the measured pitch and roll values belongs to a range associated with the electronic device 100 lying face-down and stable (e.g. level) on the surface 106. If either of these conditions is not true, then the step 327 returns the answer ‘No’ which indicates that the electronic device is not stationary and/or not orientated in a stable face-down manner on the surface 106.

Turning now to FIG. 12, an Al-powered method 381 for implementing step 380 in procedure 300 is illustrated, through which the presence or absence of a screen protector 115 on the electronic device 100 is determined. The method 381 starts at step 382 where it receives the reference image data 351 and the first and second evidence image data 353 and 355 obtained at steps 350, 352 and 354, respectively, of procedure 300. Then, through an iterative process 383, at least one feature is extracted from each of the three image data sets is extracted by using image processing tools developed for each feature. Step 383 is iterative since in a first loop one or more features are extracted from the reference image data 351, then in a second loop one or more features are extracted from the first evidence image data 353 and then in a third loop one or more features are extracted from the second evidence image data 355. In cases where only the first evidence image data 353 is obtained then there are only two iterations.

In at least one embodiment, a different number of features may be extracted for each of the 3 images. For example, N features may be extracted from the reference image data, M features may be extracted from the first evidence image data and P features may be extracted from the second evidence image data. In such cases, all the values for the (N+M+P) extracted features are provided to the machine learning unit 214 to determine the presence or absence of the screen protector 115 when the reference and evidence photos were taken. It should be noted that the same features, i.e. N+M+P features, are used when training the Al-powered model. In at least one embodiment, the features extracted from each image dataset may be different.

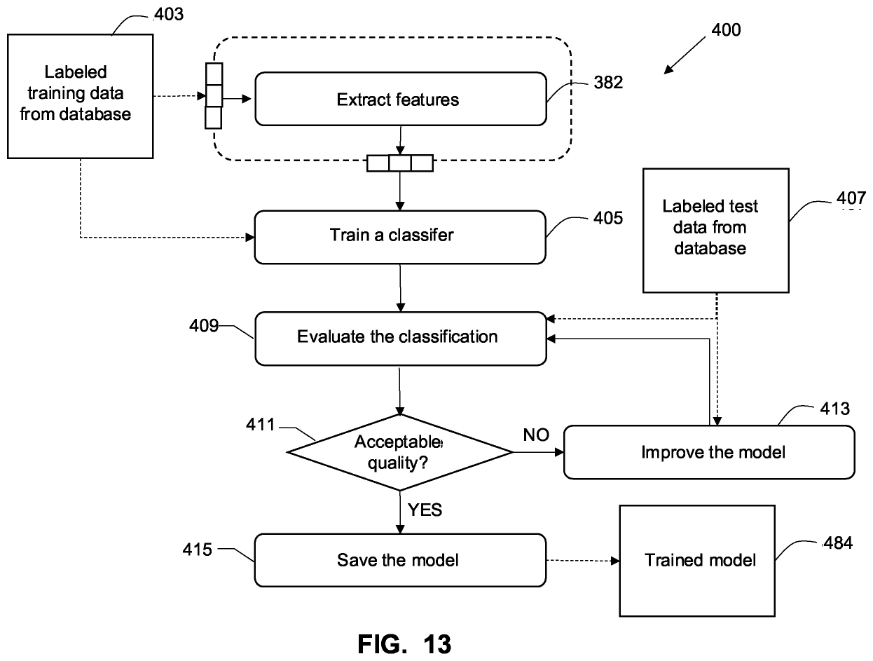

One example of a feature can be based on the color in an image. Accordingly, an image processing tool can be used to obtain the color histogram for each image dataset and some aspect of the color histogram can be used for image feature extraction. Depending on the nature of the feature, certain operations may be performed such as filtering, for example. The color histogram represents the number of pixels that have colors in each of a fixed list of color ranges. Once the at least one extracted feature for the image data is obtained in step 383, the method 381 proceeds to step 384 where a pre-trained binary classification model (i.e. the Al-powered model), which may be determined using procedure 400 (illustrated in FIG. 13), is used to determine the presence or absence of the screen protector 115 on the electronic device 100 based on the at least one extracted feature from each image data 351, 353 and 355.

Turning now to FIG. 13, a training method 400 is illustrated to train a binary classifier to detect the presence or absence of a screen protector on an electronic device 100. The method 400 may be employed by the server 202. The procedure 400 uses a collection of labeled samples which include two sets: (1) a first sample set with samples (i.e. image data) obtained in the presence of a screen protector labeled by “with screen protector” and (2) a second sample set with samples obtained in the absence of the screen protector labeled by “without screen protector”. Each sample includes image data from two evidence photos and one reference photo. This collection of samples is divided based on 10-fold cross validation to form a labeled training dataset 403 and a test dataset 407. Given each labeled sample in the training data set 403, in step 382, the procedure 400 extracts the features of the image data using a similar process as was done in method 381. Recall that providing the classifier can be provided with more than one feature from each image data. Then, using different classifier algorithms such as, but not limited to, Singular Value Decomposition (SVD), Naive Bayes or Random Forest, for example, a binary classifier is trained in step 405. At step 409, given the labeled samples in the training set 407, the accuracy of the trained model is evaluated.

Based on a predefined detection threshold (e.g. 0.8), in decision block 411, it is checked if the accuracy of the trained model, calculated based on a confusion matrix, is acceptable. The detection threshold is obtained through experiments with the goal that the desired detection accuracy is at least 80%. The confusion matrix is a matrix that is composed of 4 values: a false positive value, a false negative value, a true positive value, and a true negative value. Different performance metrics such as accuracy, precision, sensitivity and specificity can be computed based on these 4 values. There are also other metrics for evaluating the performance of the trained model, such as Receiver Operator Curves (ROC) and Area Under the Curve (AUC).

If the detection performance is acceptable, the procedure 400 is terminated by saving the trained model in a data store at step 417. Otherwise, at step 413, the procedure 400 improves the detection performance of the trained model by using different techniques, such as parameter tuning and/or applying different classifiers. This process continues until an acceptable accuracy is achieved.

Testing was performed on the screen protector detection method to determine its level of performance. The testing was done on the iPhone6 and iPhone6s smart phone models. On average, the method was able to correctly detect the presence of the screen protector in about 87% of the cases. About 500 tests were performed.

As previously described, in an alternative embodiment, the screen protection detection method 300 may be performed by the electronic device 100 and the detection results are sent to the server 202. In this case, the server 202 can instruct the electronic device 100 when it should perform the detection method. In such cases, the Al-powered model is also stored at the electronic device 100.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A method for detecting a presence or absence of a screen protector on an electronic device, wherein the method comprises:
ensuring that a front surface of the electronic device is placed in a stable manner on a flat opaque surface based on motion sensor data obtained by motion sensors of the electronic device;
disabling a flash of the electronic device, displaying a first color, optionally having a first pattern, on a display screen of the electronic device, and then taking a reference photo using a front camera of the electronic device in order to obtain reference image data;
displaying a second color, optionally having a second pattern, on the display screen of the electronic device, optionally enabling and discharging the flash and taking a first evidence photo using the front camera to obtain first evidence image data;
analyzing the reference image data and the first evidence image data to detect whether the screen protector was present or absent when the reference image data and the first image data were obtained; and
indicating, based on the analysis, that the screen protector either is present or is absent from the electronic device.

2. The method of claim 1, wherein the method further comprises displaying a white color on the display screen of the electronic device, optionally enabling and discharging the flash, and taking a second evidence photo using the front camera to obtain second evidence image data and the analysis is performed on the reference image data, the first evidence image data and the second evidence image data.

3. (canceled)

4. The method of claim 2, wherein the first and second patterns are solid, the first color being black and the second color being white.

5. The method of claim 1, wherein the motion sensor data is obtained by the electronic device and is processed to determine whether or not the front surface of the electronic device is placed in a stable manner against the flat surface and when the electronic device is not placed in a stable manner against the flat surface, the method comprises alerting a user to reposition the electronic device to so that the electronic device is placed in a stable manner against the flat surface.

6. The method of claim 5, wherein the motion sensor data includes acceleration data and rotation data, and the method determines that the electronic device is placed in a stable manner against the flat surface based on comparing a magnitude of an acceleration value determined from the acceleration data to an acceleration threshold and comparing pitch and roll values from the rotation data to ranges of roll and pitch values that are associated with a face down orientation for the electronic device.

7. The method of claim 1, wherein the analysis of the image data comprises extracting values for at least one feature of the obtained image data using image processing techniques and wherein the method further comprises processing the values for the at least one extracted feature of the obtained image data with a pre-trained binary classifier to determine whether the input values belong to a “with screen protector” which in indicates that the electronic protector is present with the electronic device or a “without screen protector” class which indicates that the electronic protector is not with the electronic device.

8. (canceled)

9. The method of claim 7, wherein the pre-trained binary classifier is based on an XGBoost algorithm, Singular Value Decomposition (SVD), Naive Bayes, Logistic Regression, k-Nearest Neighbors (k-nn), Gradient boosting, Random Forest or an ensemble method.

10. The method of claim 14, wherein the at least one feature is any combination of a color histogram, a Histogram of Oriented Gradients, a Gradient location-orientation histogram, an Image Gradient, an Image Laplacian, textural features, fractal analysis, Minkowski functionals, a wavelet transform, a gray-level co-occurrence matrix, a size zone matrix, and run length matrix (RLM).

11. The method of claim 10, wherein the values for the at least one feature are computed over a filtered version of the reference and evidence image data.

12. The method of claim 1, wherein a device processing unit of the electronic device is used to ensure that the front surface of the electronic device is placed in a stable manner on a flat opaque surface.

13. The method of claim 1, wherein the image data is sent to a server where a server processing unit performs the analysis of the image data to determine the presence or absence of the screen protector on the electronic device and/or a device processing unit of the electronic device is used to perform the analysis of the image data to determine the presence or absence of the screen protector on the electronic device.

14. (canceled)

15. (canceled)

16. A system for detecting a presence or absence of a screen protector on an electronic device, wherein the system comprises:
the electronic device including:
a display screen for generating and displaying colors,
a camera for taking photos and obtaining image data therefrom;
a flash for the camera, the flash being optional;
motion sensors for obtaining motion sensor data for the electronic device;
a communication device for communicating with remove device;
a memory for storing programming instructions for performing one or more steps of a screen protector detection method; and
a device processing unit for controlling the operation of the electronic device, the device processing unit being operatively coupled to the display screen, the camera, the flash, the motion sensors, the communication device and the memory, wherein when the device processing unit, when executing the software instructions, is configured to:
obtain the motion sensor data that is used to ensure that a front surface of the electronic device is placed in a stable manner on a flat opaque surface;
disable the flash, display a first color, optionally having a pattern, on the display screen, and take a reference photo using the front camera in order to obtain reference image data;
display a second color, optionally having a pattern, on the display screen of the electronic device, optionally enabling and discharging the flash and taking a first evidence photo using the front camera to obtain first evidence image data; and
a server comprising a server processing unit that controls the operation of the server and a communication unit that is coupled to the server processing unit, wherein the server processing unit is configured to send a command to the electronic device to start the method for detecting the presence of absence of the screen protector,
wherein the reference image data and the first evidence image data are analyzed to detect whether the screen protector was present or absent when the reference image data and the first image data were obtained; and
an indication is provided, based on the analysis, that the screen protector either is present or is absent from the electronic device.

17. The system of claim 16, wherein the device processing unit is further configured to display a second color on the display screen of the electronic device, optionally enable and discharge the flash, and take a second evidence photo using the front camera to obtain second evidence image data and the analysis is performed on the reference image data, the first evidence image data and the second evidence image data.

18. (canceled)

19. The system of claim 17, wherein the first and second patterns are solid, the first color being black and the second color being white.

20. The system of claim 16, wherein the motion sensor data is obtained by the electronic device and is processed to determine whether or not the front surface of the electronic device is placed in a stable manner against the flat surface and when the electronic device is not placed in a stable manner against the flat surface, the device processing unit is configured to generate a notification signal to alert a user to reposition the electronic device to so that the electronic device is placed in a stable manner against the flat surface.

21. The system of claim 20, wherein the motion sensor data includes acceleration data and rotation data, and the electronic device is determined to be placed in a stable manner against the flat surface based on comparing a magnitude of an acceleration value determined from the acceleration data to an acceleration threshold and comparing pitch and roll values from the rotation data to ranges of roll and pitch values that are associated with a face down orientation for the electronic device.

22. The system of claim 16, wherein the analysis of the image data comprises extracting values for at least one feature of the obtained image data using image processing techniques and the values for the at least one extracted feature of the obtained image data are processed by a pre-trained binary classifier to determine whether the input values belong to a “with screen protector” which indicates that the electronic protector is present with the electronic device or a “without screen protector” class which indicates that the electronic protector is not with the electronic device.

23. (canceled)

24. The system of claim 22, wherein the pre-trained binary classifier is based on an XGBoost algorithm, Singular Value Decomposition (SVD), Naive Bayes, Logistic Regression, k-Nearest Neighbors (k-nn), Gradient boosting, Random Forest or an ensemble method.

25. The system of claim 16, wherein the at least one feature is any combination of a color histogram, a Histogram of Oriented Gradients, a Gradient location-orientation histogram, an Image Gradient, an Image Laplacian, textural features, fractal analysis, Minkowski functionals, a wavelet transform, a gray-level co-occurrence matrix, a size zone matrix, and run length matrix (RLM).

26. The system of claim 25, wherein the values for the at least one feature are computed over a filtered version of the reference and evidence image data.

27. The system of claim 16, wherein the device processing unit is configured to analyze the motion sensor data to ensure that the front surface of the electronic device is placed in a stable manner on a flat opaque surface.

28. The system of claim 16, wherein the image data is sent to the server and the server processing unit is configured to perform the analysis of the image data to determine the presence or absence of the screen protector on the electronic device and/or a device processing unit of the electronic device is configured to perform the analysis of the image data to determine the presence or absence of the screen protector on the electronic device.

29. (canceled)
